(19) United States
(12) Patent Application Publication
(10) Pub. No.: US 2015/0275983 A1
(43) Pub. Date: Oct. 1, 2015

(54) CLUTCH FRICTION DISC

(71) Applicant: VALEO MATERIAUX DE FRICTION, Limoges (FR)

(72) Inventors: Loïc Adamczak, Roussac (FR); Gérard Crosland, La Souterraine (FR); Franck Delavente, Verneuil Sur Vienne (FR); Matthieu Morpain, Limoges (FR); Patrice Malagnac, Couzeix (FR)

(73) Assignee: VALEO MATERIAUX DE FRICTION, Limoges (FR)

(21) Appl. No.: 14/433,516

(22) PCT Filed: Sep. 24, 2013
(86) PCT No.: PCT/FR2013/052226

§ 371 Date: Apr. 3, 2015

(30) Foreign Application Priority Data
Oct. 4, 2012 (FR) 1259444

(51) Int. Cl. F16D 13/68

(52) U.S. Cl. CPC F16D 13/68; F16D 2013/642

(57) ABSTRACT

A clutch friction disc (1) having at least two opposed annular friction linings (2, 2′), each fastened on a support (4, 4′), and elastic means (3) arranged between the supports (4, 4′) so as to allow the latter to move closer or farther away axially. Each support (4, 4′) has a tongue (6) for fastening to a central hub (12), located on the inner periphery of the support (4, 4′). Each fastening tongue (6) is retained axially between the hub (12) and a clamping washer (18) fastened to the hub (12) in order to prevent deformation of the tongue (6) during operation.

The present invention relates to a clutch friction disc, in particular for a motor vehicle.

A motor vehicle clutch is intended to transmit a torque between a driving shaft, for example a crankshaft of an internal combustion engine, and an input shaft of a gearbox. The clutch has for this purpose a mechanism coupled to the driving shaft and a friction disc coupled to the input shaft of the gearbox.

The clutch mechanism has a pressure plate and a reaction plate, which are rotationally integral and are movable axially with respect to one another so as to grip or release the friction disc respectively in an engagement phase and a disengagement phase.

The friction disc has two opposing friction linings connected to an annular flange or to a friction disc hub. Each lining has an annular friction body fastened on an annular support. The supports are generally metallic shims having a thickness between 0.2 and 1 mm. The friction bodies are conventionally made of a fibrous material, a binder, and fillers, as is known in particular from the document FR 2 941 758 of the present Applicant.

In an engagement phase, the pressure plate and the reaction plate are intended to come into abutment against the friction bodies of the linings.

The friction disc must conform to a variety of technical constraints.

On the one hand it is advisable to limit the mass and inertia of the friction disc. For this it is advisable to limit the axial and radial dimensions of the friction linings. It can also be preferable to avoid fastening the friction bodies to the supports using rivets, given the mass of the latter. It will then be preferable to effect such fastening by adhesion or by hot pressing when this is possible.

On the other hand it is advisable to be able to engage and disengage progressively, to progressively increase or reduce the torque transmitted from the driving shaft to the gearbox by means of the friction disc.

The patent FR 2 871 538 of the present Applicant thus proposes to interpose elastic means between the two opposing friction linings, more precisely between the two supports of said linings. These elastic means can comprise both elastic tongues, extending circumferentially and shaped into at least one of the supports, and concentric annular elements made of elastomer.

Patent application DE 10 2010 024 460 proposes to provide the progressive functionality with the aid of metallic elements, deformable elastically in the axial direction, installed between the friction linings.

In both cases the temperature difference between the outer periphery of the friction disc, which is subject to friction and to heating during operation, and the inner periphery of the friction disc generates differential expansions which cause deformation of the supports, in particular undulations or waving in said supports.

Such deformations have negative effects on proper operation of the clutch, and can damage or detach the friction bodies. It is therefore advisable to avoid or reduce these deformations.

To this end, the invention proposes a clutch friction disc having at least two opposed annular friction linings each comprising at least one friction body, a support, and elastic means arranged between the supports so as to allow the supports to move closer or farther away axially by compression or relaxation of the elastic means, the friction body being fastened on the support, each support having an annular part and a fastening tongue connected to a central hub and located on the inner periphery of the support, wherein it also has a clamping washer, said clamping washer being fastened to the hub; and each fastening tongue is retained axially between the hub and the clamping washer in order to prevent deformation of the tongue during operation.

The tongues of the supports are thus pressed against the hub by the clamping washers, which prevents the tongues from deforming, in particular axially outward. It has been found that a structure of this kind considerably reduces permanent deformation of the supports due to temperature differences during operation.

According to a characteristic of the invention, each support has a deformable zone located radially between the tongue and the annular part, said deformable zone being located radially outside the corresponding clamping washer in order to allow the annular parts of the supports to move closer or farther away by deformation of said deformable zone.

Preferably each tongue extends circumferentially and has a first end connected to the inner periphery of the annular part of the corresponding support, and a second end interacting with means for fastening to the hub, for example rivets.

In addition, in a rest position the supports can be substantially planar, which means that each tongue extends in the same plane as the annular part of the corresponding support. The rest position is defined by the disengaged position, in which the friction bodies are not subjected to the opposing axial forces of the pressure plate and the reaction plate.

According to an embodiment of the invention, the elastic means have at least one deformable element made of elastomer.

In such a case the elastic means can have continuous or discontinuous concentric annular elements made of elastomer.

According to another embodiment of the invention the elastic means have at least one metal sheet that is elastically deformable in the axial direction.

The invention will be better understood, and other details, characteristics, and advantages of the invention will emerge, upon reading the description below provided as a non-limiting example with reference to the attached drawings, in which:

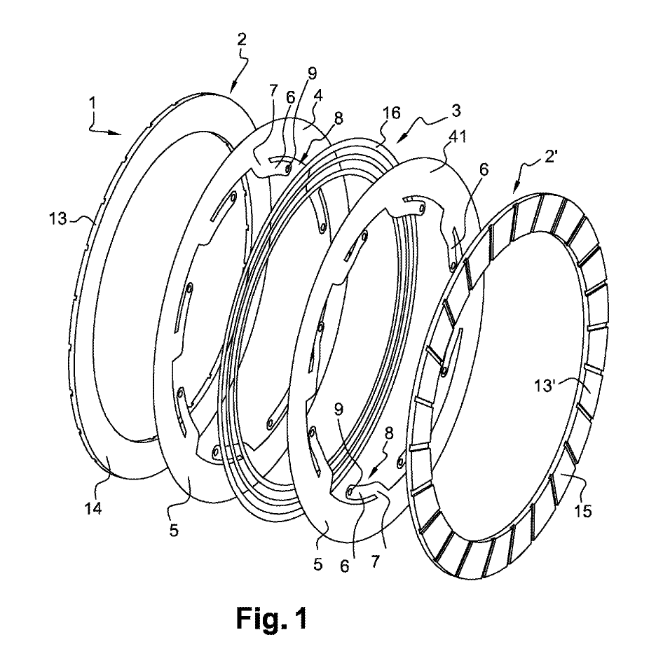

FIG. 1 is an exploded perspective view of a portion of a friction disc of the existing art;

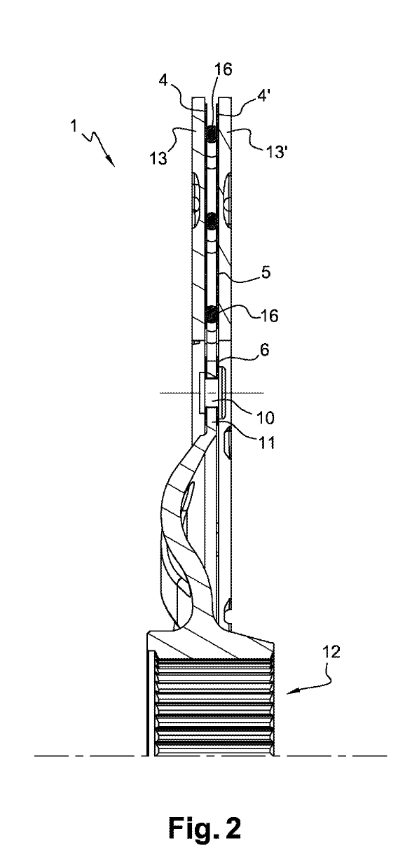

FIG. 2 is a half-view in axial section of the friction disc of the existing art;

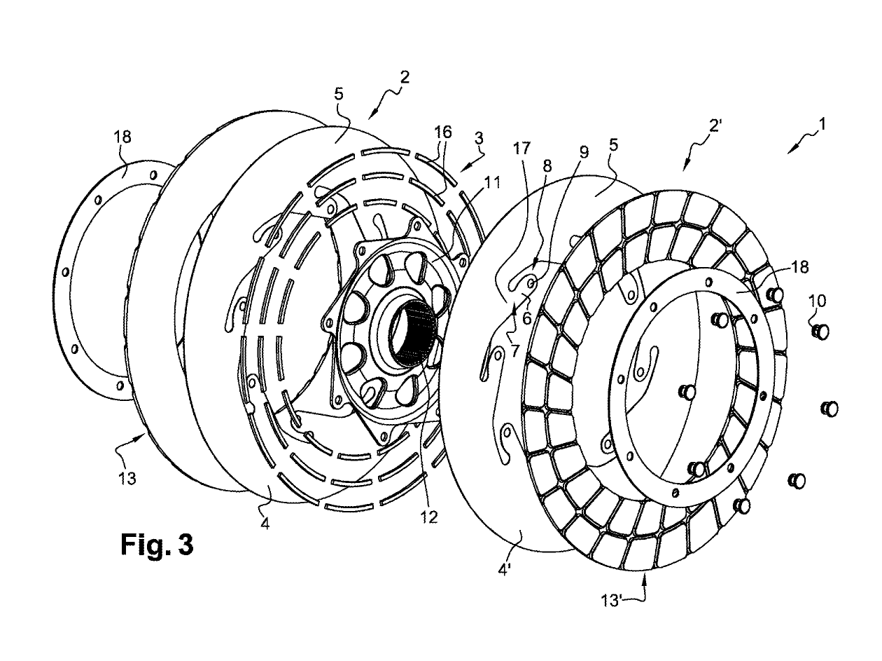

FIG. 3 is an exploded perspective view of a friction disc according to a first embodiment of the invention;

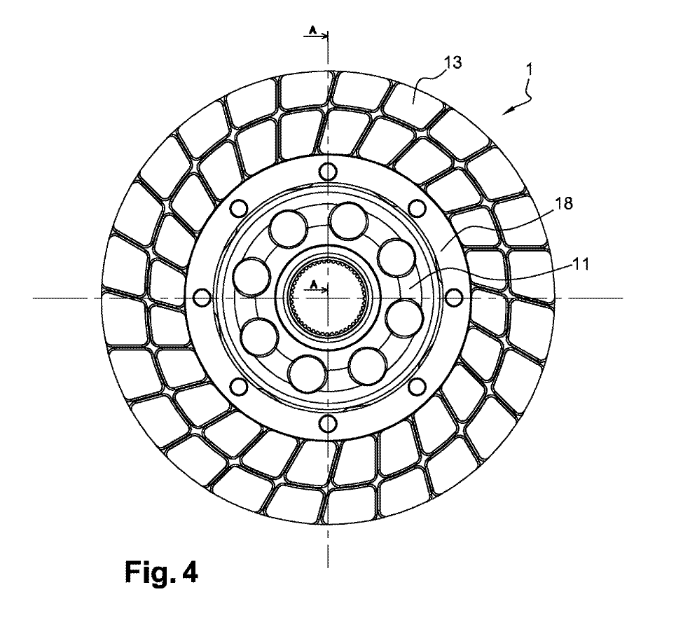

FIG. 4 is a frontal view of the friction disc of FIG. 3;

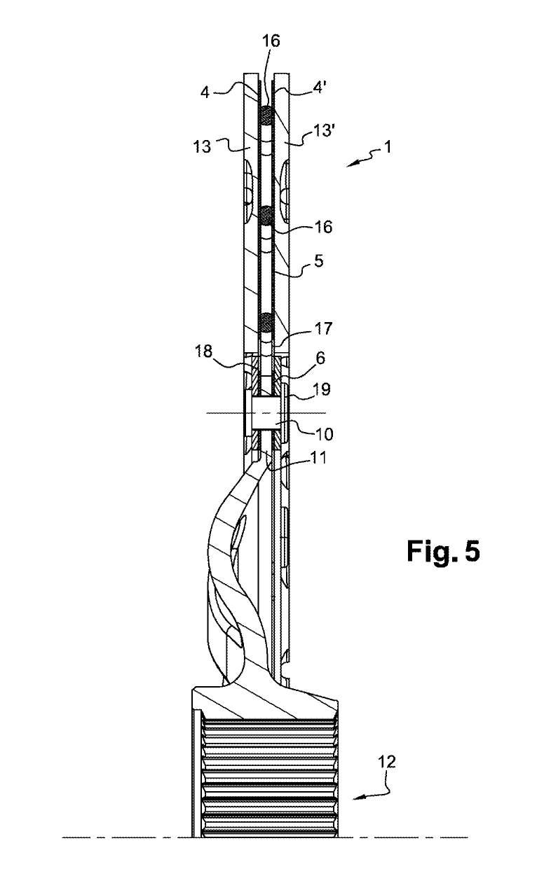

FIG. 5 is a half-view in section along line A-A of FIG. 4;

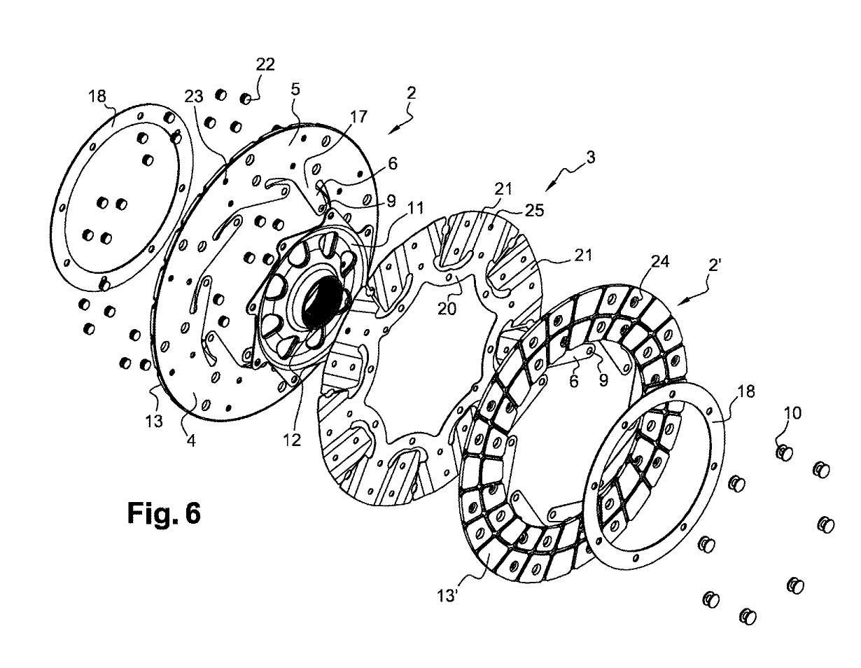

FIG. 6 is an exploded perspective view of a friction disc according to a second embodiment of the invention;

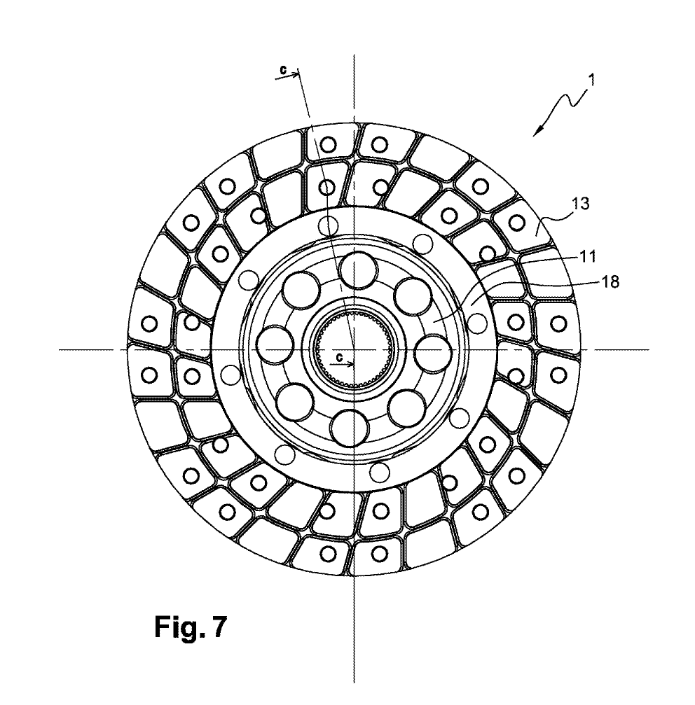

FIG. 7 is a frontal view of the friction disc of FIG. 6;

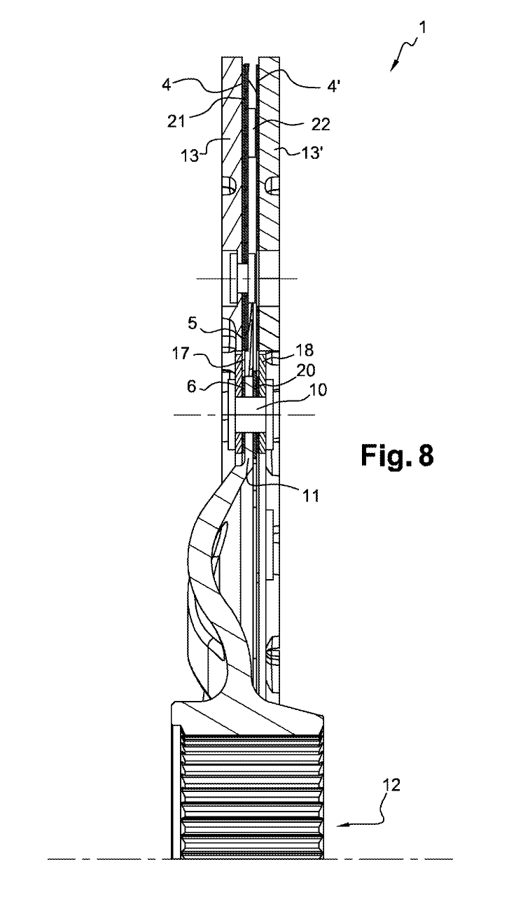

FIG. 8 is a half-view in section along line C-C of FIG. 7.

FIGS. 1 and 2 depict a friction disc 1 of the existing art, having two opposed and coaxial annular friction linings 2, 2′ between which elastic progressivity means 3 are arranged.

Each friction lining 2, 2′ has a support 4, 4′ constituted by an annular shim, a thin sheet of metallic material having a thickness generally between 0.2 and 1 mm. Shims 4, 4′ each have an annular part 5 and tabs 6 extending from the radially inner periphery of annular part 5. Each tab 6 has a first end 7 connected to the radially inner periphery of annular part 5, and a second end 8 having a hole 9 for passage of a rivet 10 for fastening to a flange 11 of a hub 12 (FIG. 2). Hub 12, or more generally friction disc 1, is intended to be coupled to an input shaft of a gearbox, as is known per se.

Ends 7 and 8 are axially offset with respect to one another. More particularly, second end 8 is spaced axially away from first end 7 in the direction of the opposite shim 2, 2′. Tabs 6 are elastically and axially deformable in order to allow one shim to move closer to or farther away from the other.

Annular friction bodies 13, 13′ are mounted on those faces of shims 4, 4′ which are opposite to elastic means 3. These friction bodies 13, 13′ are conventionally made of a fibrous material, a binder, and fillers, as known in particular from the document FR 2 941 758 of the present Applicant.

Friction bodies 13, 13′ have a thickness of between 1.5 and 5 mm, for example.

Each friction body 13, 13′ has a radial fastening face 14 facing toward the corresponding shim 2, 2′, and a radial friction face 15 opposite to fastening face 14.

Fastening faces 14 are, for example, adhesively bonded onto the corresponding shims 2, 2′.

Friction faces 15 are intended to interact with a pressure plate and a reaction plate of a clutch mechanism (not depicted) in order to transmit a torque from a driving member, such as a crankshaft of an internal combustion engine, to the input shaft of the gearbox.

Elastic means 3 are constituted by concentric annular cords 16 made of elastomer, for example of silicone.

During operation, in an engagement phase friction disc 1 is gripped between the pressure plate and the reaction plate so that linings 2, 2′ move closer to one another by deformation of tabs 6 and of cords 16 made of elastomer. Compression of cords 16 made of elastomer allows an axial displacement between the two linings 2, 2′ which is between 0.3 and 1.2 mm.

This allows the torque of the driving shaft, rotationally coupled to the pressure plate and to the reaction plate, to be transmitted progressively to the input shaft of the gearbox.

A friction disc 1 of this kind is described in further detail in patent FR 2 871 538 of the present Applicant.

As indicated previously, the temperature difference between the outer periphery of friction disc 1, subject to friction and to heating during operation, and the inner periphery of friction disc 1 generates differential expansions that cause deformation of supports 4, 4′, in particular undulations or waving of said supports 4, 4′.

FIGS. 3 to 5 depict a friction disc 1 according to a first embodiment of the invention. This friction disc 1 has, as previously, two opposed annular friction linings 2, 2′ each having a friction body 13, 13′ fastened on a support 4, 4′, and elastic means 3 arranged between the opposed supports in order to allow the supports to move closer or farther away axially.

In this embodiment, elastic means 3 are discontinuous and concentric cords 16 made of elastomer. The cords can of course be continuous as in the case of the friction disc of FIG. 1.

Each support 4, 4′ has an annular part 5 and tongues 6 for fastening to a central hub 12, for example eight in number. Each tongue 6 extends circumferentially and has a first end 7 connected to the inner periphery of annular part 5 of the corresponding support 4, 4′ by means of a deformable zone 17, and a second end 8 interacting with means for fastening to a flange 11 of a hub 12, for example such as rivets 10.

Each fastening tongue 6 is retained axially between flange 11 of hub 12 and a clamping washer 18 fastened to flange 11 with the aid of rivets 10.

As is more easily visible in FIG. 5, heads 19 of rivets 10 abut against the “outer” faces of clamping washers 18, the “inner” faces of washers 18 causing fastening tabs 6 to be pressed on either side of radial flange 11.

Deformable zones 17 of supports 4, 4′ are located radially outside clamping washers 18 in order to allow annular parts 5 of supports 4, 4′ to move closer or farther away axially by deformation of deformable zones 17.

In a rest position supports 4, 4′ are substantially planar, so that tabs 6 and annular part 5 of each support 4, 4′ extend radially in the same plane.

FIGS. 6 to 8 illustrate a second embodiment of the invention, which differs from the first embodiment in that elastic means 3 are constituted by an annular metal sheet having a radial annular zone 20 from which elastic parts 21 extend radially outward. Each elastic part 21 is integral with the aforesaid annular zone 20, and extends obliquely with respect to the radial plane. This part 21 can thus be elastically deformed in response to opposing axial forces exerted by linings 2, 2′.

In this embodiment as well, friction bodies 13, 13′ are fastened to supports 4, 4′ by means of rivets 22 engaged into holes 23, 24 in supports 2, 2′ and in friction bodies 13, 13′. These rivets 10 are engaged into holes 25 in elastic parts 21 and thus serve to fasten annular metal sheet 3.

In each of the two embodiments of the invention, clamping washers 18 allow deformation of tabs 6 to be avoided; only zones 17 are deformed. As indicated previously, it has been found that such a structure considerably reduces the deformation of supports 4, 4′ during operation.

1. A clutch friction disc (1) having at least two opposed annular friction linings (2, 2′) each comprising at least one friction body (13, 13′), a support (4, 4′), and elastic means (3) arranged between the supports (4, 4′) so as to allow the supports (4, 4′) to move closer or farther away axially by compression or relaxation of the elastic means (3), the friction body being fastened on the support (4, 4′), each support (4, 4′) having an annular part (5) and a fastening tongue (6) connected to a central hub (12) and located on the inner periphery of the support (4, 4′),
wherein it also has a clamping washer (18), said clamping washer being fastened to the hub (12); and each fastening tongue (6) is retained axially between the hub (12) and the clamping washer (18) in order to prevent deformation of the tongue (6) during operation.

2. The friction disc (1) according to claim 1, wherein each support (4, 4′) has a deformable zone (17) located radially between the tongue (6) and the annular part (5), said deformable zone (17) being located radially outside the corresponding clamping washer (18) in order to allow the annular parts (5) of the supports (4, 4′) to move closer or farther away by deformation of said deformable zone (17).

3. The friction disc (1) according to claim 1 or 2, wherein each tongue (6) extends circumferentially and has a first end (7) connected to the inner periphery of the annular part (5) of the corresponding support (4, 4′), and a second end (8) interacting with means (10) for fastening to the hub (12).

4. The friction disc (1) according to claim 1, wherein in a rest position the supports (4, 4′) are substantially planar.

5. The friction disc (1) according to claim 1, wherein the elastic means (3) have at least one deformable element (16) made of elastomer.

6. The friction disc (1) according to claim 5, wherein the elastic means (3) have continuous or discontinuous concentric annular elements (16) made of elastomer.

7. The friction disc (1) according to claim 1, wherein the elastic means (3) have at least one metal sheet (20, 21) that is elastically deformable in the axial direction.

8. The friction disc (1) according to claim 1, wherein the means for fastening the tabs (6) to the hub (12) comprise rivets (10).

9. The friction disc (1) according to claim 2, wherein each tongue (6) extends circumferentially and has a first end (7) connected to the inner periphery of the annular part (5) of the corresponding support (4, 4′), and a second end (8) interacting with means (10) for fastening to the hub (12).

10. The friction disc (1) according to claim 2, wherein in a rest position the supports (4, 4′) are substantially planar.

11. The friction disc (1) according to claim 3, wherein in a rest position the supports (4, 4′) are substantially planar.

12. The friction disc (1) according to claim 2, wherein the elastic means (3) have at least one deformable element (16) made of elastomer.

13. The friction disc (1) according to claim 3, wherein the elastic means (3) have at least one deformable element (16) made of elastomer.

14. The friction disc (1) according to claim 4, wherein the elastic means (3) have at least one deformable element (16) made of elastomer.

15. The friction disc (1) according to claim 2, wherein the elastic means (3) have at least one metal sheet (20, 21) that is elastically deformable in the axial direction.

16. The friction disc (1) according to claim 3, wherein the elastic means (3) have at least one metal sheet (20, 21) that is elastically deformable in the axial direction.

17. The friction disc (1) according to claim 4, wherein the elastic means (3) have at least one metal sheet (20, 21) that is elastically deformable in the axial direction.

18. The friction disc (1) according to claim 5, wherein the elastic means (3) have at least one metal sheet (20, 21) that is elastically deformable in the axial direction.
